(19) United States
(12) Patent Application Publication
(10) Pub. No.: US 2002/0031351 A1
(43) Pub. Date: Mar. 14, 2002

(54) Printing apparatus

(76) Inventor: Futoshi Hirai, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/946,485

(22) Filed: Sep. 6, 2001

(30) Foreign Application Priority Data
Sep. 12, 2000 (JP) 2000-276723

(51) Int. Cl. G03B 17/48

(52) U.S. Cl. 396/429

(57) ABSTRACT

A printing apparatus includes a loading part for receiving a printing medium loaded thereto, the loading part being capable of receiving a function-extension unit when the printing medium is unloaded, and a connection member for forming an electrical connection to the function-extension unit loaded to the loading part.

### BACKGROUND OF THE INVENTION

1. Field of the Invention

The present invention relates to printing apparatuses, in particular, to a printing apparatus to which a printing medium is detachably loaded.

2. Description of the Related Art

A camera capable of receiving an electronic imaging element in a space for receiving a silver-salt film has been proposed in, for example, Japanese Patent Laid-Open No. 8-251461, in which the silver-salt film and the electronic imaging element can be selectively used. The proposed camera is provided with a separate base unit which has a memory function, a display function, and/or a print function.

A printer-integrated camera having a rotatable printer has been proposed in, for example, Japanese Patent Laid-Open No. 10-322636.

However, in order for that the silver-salt film and an electro-photographic system are selectively used, the electronic imaging element is detachably loaded to the camera proposed in Japanese Patent Laid-Open No. 8-251461. As a result, it becomes necessary to devise a method for accurately positioning the electronic imaging element and to provide an optical system for the electronic imaging element, whereby configuration of the camera becomes complex and the manufacturing costs increase. Although a print function can be added by providing the base unit separately, it is incommodious to carry both the separate base unit and a camera, and to incur extra costs by obtaining the base unit.

The printer of the printer-integrated camera proposed in Japanese Patent Laid-Open No. 10-322636 is provided exclusively for printing and is used only for printing. The printer becomes inutile when printing is not performed. For users, a camera provided with such a mechanism which is not used often is undesirable.

The printer-integrated camera is a complex apparatus of a new genre or kind which is formed with a camera and a printer assembled as a unit, and has not yet become popular as a household appliance because, for example, function extensions have not been sufficiently considered and it is not very useful.

### SUMMARY OF THE INVENTION

Accordingly, it is an object of the present invention to provide a printing apparatus of which functions can be easily extended, that is, more functions can be added and which can thereby become useful.

To this end, according to one aspect of the present invention, a printing apparatus comprises a loading part that receives a printing medium loaded thereto, the loading part being capable of receiving a function-extension unit when the printing medium is unloaded; and a connection member that forms an electrical connection to the function-extension unit loaded to the loading part.

According to another aspect of the present invention, a printing apparatus comprises a loading part that receives a printing medium loaded thereto, the loading part being capable of receiving a function-extension unit when the printing medium is unloaded; and a determination device that determines the function-extension unit loaded to the loading part.

Further objects, features and advantages of the present invention will become apparent from the following description of the preferred embodiments with reference to the attached drawings.

### BRIEF DESCRIPTION OF THE DRAWINGS

FIG. 1 is a perspective front view of a printer-integrated camera according to an embodiment of the present invention.

FIG. 2 is a perspective rear view of the printer-integrated camera shown in FIG. 1.

FIG. 3 is a sectional view of the printer-integrated camera shown in FIG. 1.

FIG. 4 is a block diagram showing functions of the printer-integrated camera shown in FIG. 1.

FIG. 5 is a perspective view of the printer-integrated camera shown in FIG. 1, in which a cartridge 200 is removed from a camera body 100 of the printer-integrated camera.

FIG. 6 is a perspective view of the printer-integrated camera shown in FIG. 1, in which a function-extension unit is being loaded to the camera body 100.

FIG. 7 is a sectional view of the camera body 100 of the printer-integrated camera shown in FIG. 1, in which the function-extension unit is loaded.

FIG. 8 is a flowchart showing steps of selecting modes when the printer-integrated camera is loaded with the cartridge 200 or a function-extension unit 400.

FIG. 9 is a flowchart showing the steps of selecting modes when the printer-integrated camera is loaded with the cartridge 200 or the function-extension unit 400.

### DESCRIPTION OF THE PREFERRED EMBODIMENTS

Preferred embodiments according to the present invention are described below with reference to the drawings.

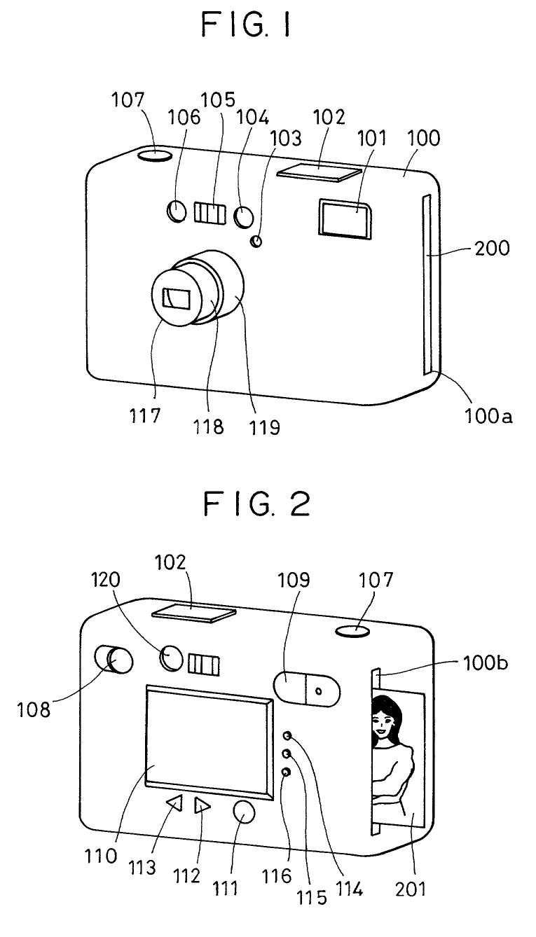

FIG. 1 is a perspective front view of a printer-integrated camera which is used in an embodiment of the present invention. FIG. 2 is a perspective rear view of the printer-integrated camera shown in FIG. 1.

The printer-integrated camera includes a digital camera for storing images captured by using an imaging element such as a charge-coupled device (CCD) in a memory, and a printer for printing the images stored in the memory on printing sheets by ink-jet recording and discharging the printing sheets.

In FIG. 1, the printer-integrated camera is provided at the front side of a camera body 100 thereof with a lens barrel unit (a lens barrel 118 and a cam barrel 119) including an imaging lens unit 117. The printer-integrated camera is also provided at the front side of the camera body 100 with an automatic exposure (AE) window 103 for photometry, a light-emission window for automatic focusing (AF light-emission window) 104, a light-receiving window for automatic focusing (AF light-receiving window) 106, a viewfinder object-window 105, and a flash 101. The camera body 100 is provided at the upper face thereof with a liquid crystal data-display panel 102, and a release button 107.

The camera body 100 is provided at the right side thereof (in front view) with a loading slot 100a for loading a cartridge 200 for feeding printing sheets, which receives a plurality of the printing sheets.

In FIG. 2, the printer-integrated camera is provided at the rear side of the camera body 100 with a main switch 108, a zoom button 109, a liquid crystal image-display panel 110, a viewfinder ocular window 120, an imaging-mode selecting button 114, an image-quality-mode selecting button 115, a print-quantity setting button 116, an image-transfer button 112, an image-returning button 113, and a print button 111. The camera body 100 is provided at the left side thereof (in front view) with a printing-sheet discharging slot 100b for discharging a printed printing sheet 201. In FIG. 2, the printing sheet 201 which is fed from the cartridge 200 loaded to the camera body 100 is printed with an image and is discharged from the printing-sheet discharging slot 100b. According to the present embodiment, the overall cartridge 200 is received in the camera body 100, as is apparent from FIG. 2.

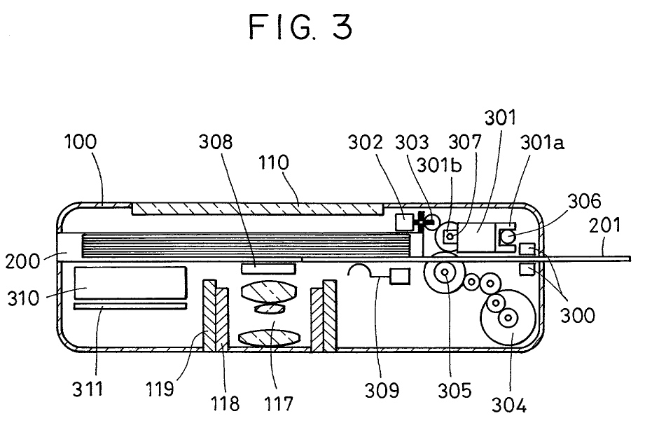

The inner configuration of the printer-integrated camera is described below with reference to FIG. 3. FIG. 3 is a sectional view of the printer-integrated camera shown in FIG. 1, FIG. 3 showing the printer-integrated camera in a mode of printing.

In FIG. 3, the camera body 100 is provided therein with a space for receiving the cartridge 200 or a function-extension unit which is described below. The camera body 100 is provided in the space with tabs 309 as a loaded-material-detecting sensor for detecting the cartridge 200 or the function-extension unit when loaded, a printing-sheet photo-interrupter (hereinafter referred to as a printing-sheet “PI”) 300 for determining a transfer state of the printing sheet fed from the cartridge 200, a print head 301 for printing image data on the printing sheet, a print-head PI 302 for determining a driven state of the print head 301, a comb-teeth gear 303 for reflecting the driven state of the print head 301, a motor 304 for driving a printing mechanism, a transfer roller 305 for transferring the printing sheet 201, a restricting member 306 for restricting pivoting motion of the print head 301, a driving member 307 for driving the print head 301, and a photoelectric conversion device 308 for converting object light which has passed through the imaging lens unit 117 into an electric signal. The tabs 309 can be electrically connected to a material (the function-extension unit described below) loaded into the camera body 100 through the loading slot 100a. The camera body 100 is also provided therein with a main battery 310, and a main memory 311 for storing captured image data.

The print head 301 is provided with a print-head driving part 301b and a print-head restricting part 301a. The driving member 307 and the print-head driving part 301b are provided with threads. The print head 301 is driven in a direction perpendicular to the drawing by rotation of the driving member 307.

According to the present embodiment, an electrical connection member is not provided at the side of the cartridge 200; therefore, it is determined that the material that is loaded is the cartridge 200 because current is not detected via the tabs 309. The detection of the cartridge 200 may be arranged such that the cartridge 200 is provided with an electrical connection member, and so that information about the cartridge 200 is transferred via the electrical connection member and the tabs 309.

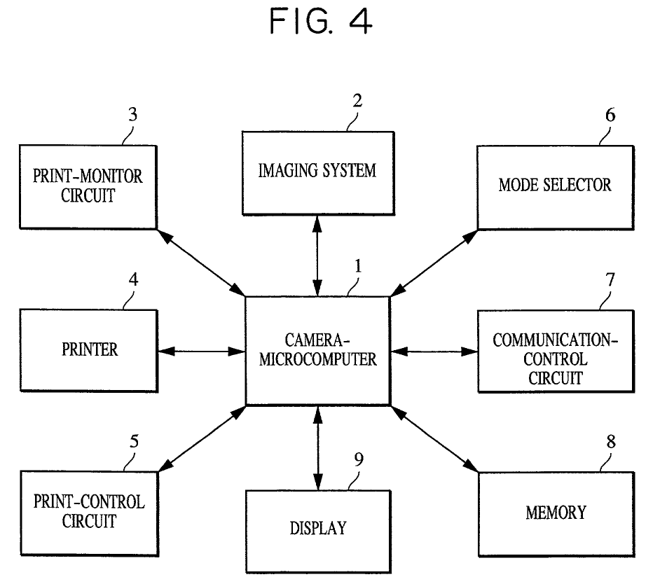

With reference to FIG. 4, functions of the printer-integrated camera is described below. FIG. 4 is a block diagram showing the functions of the printer-integrated camera shown in FIG. 1.

In FIG. 4, the printer-integrated camera includes a camera-microcomputer 1 for controlling the overall printer-integrated camera, an imaging system 2 for outputting an image signal of a captured object image, a print-monitor circuit 3 for monitoring print operations, a printer 4 for printing image data on a printing sheet fed from the cartridge 200, a print-control circuit 5 for controlling print operations of the printer 4, a mode selector 6 for selecting an imaging mode, an image-quality mode, and a print-output mode, a communication control circuit 7 for communicating with the function-extension unit which is described below, a memory 8 including the main memory 311 for storing the image data, and a display 9 for displaying the image data. Each function is described below.

The operation of the printer-integrated camera is described below with reference to FIGS. 1 to 4.

When the main switch 108 is put on, current is applied to the printer-integrated camera. The current is supplied by the main battery 310. When the current is applied, the camera-microcomputer 1 drives the imaging system 2 such that the lens barrel 118 and the cam barrel 119 are driven so as to be set in an imaging position.

The user selects an imaging mode by using the mode selector 6. The printer-integrated camera according to the present embodiment operates in general imaging modes, such as a full automatic imaging mode, a portrait mode, and a serial imaging mode. The desired imaging modes can be selected by operating the imaging-mode selecting button 114. When one of the imaging modes is selected by operating the imaging-mode selecting button 114, a signal of the selected imaging mode is inputted to the camera-microcomputer 1, thereby setting the selected imaging mode. The user selects the image-quality mode by using the mode selector 6. According to the present embodiment, image-data compression modes, such as a high image-quality (low compression ratio) mode, a normal image-quality (intermediate compression ratio) mode, and a low image-quality (high compression ratio) mode, are provided. The image-quality modes are selected by operating the image-quality-mode selecting button 115. A signal of the selected image-quality mode is inputted to the camera-microcomputer 1, thereby setting the selected image-quality mode.

When imaging, when the user controls the field angle by operating the zoom button 109 and depresses the release button 107 to a first stroke level, the camera-microcomputer 1 determines the exposure-control value in accordance with the amount of light incident via the AE window 103, the data of distance measured by using a near-infrared light emitted from the AF light-emission window 104 and received through the AF light-receiving window 106, and conditions required for exposure operations such as whether or not flashing by the flash 101 is necessary. When the user further depresses the release button 107 for imaging, the camera-microcomputer 1 performs a series of exposure operations, such as lens-driving for focusing, control of the shutter speed, control of the aperture amount of a diaphragm, and flashing, as needed.

The object light passing through the imaging lens unit 117 in the exposure operations is converted into image data as electric signals by the photoelectric conversion device 308. The image data are converted into digital signals by an A/D conversion device (not shown). The image data having a large volume when captured are compressed so that the volume is reduced. The compressed image data are inputted to the memory 8 and are stored. In particular, the image data are stored in the main memory 311. It is known that degradation of the quality of image data varies according to the compression ratio of the image data. That is, by increasing the compression ratio of the image data, the volume of the image data can be reduced; however, this results in a degradation of image quality. When the compression ratio of the image data is decreased, the volume of the image data cannot be significantly reduced but the degradation of the image quality can be suppressed.

After exposure, the camera-microcomputer 1 drives the display 9 which is the liquid crystal image-display panel 110 and displays the captured image data. The exposure operations are repeated in the above-described order, and the captured image data are stored in the main memory 311.

When the user desires to print-output the captured image data, a print-output mode is selected by the mode selector 6 by operating the print-quantity selecting button 116. Although according to the present embodiment, a button is used exclusively for this purpose, the arrangement is not limited and a button displayed in the liquid crystal image-display panel 110, for example, may be used for selection.

The image data stored in the main memory 311 are searched while they are displayed on the liquid crystal image-display panel 110 by operating the image-transfer button 112 and the image-returning button 113, thereby selecting desired one of the image data. When the user presses the print button 111, the camera-microcomputer 1 commands that a print operation be performed. When performing the print operation, the print-control circuit 5 outputs the image data stored in the main memory 311 from the printer 4.

The print operation is described below in detail.

When the print-control circuit 5 drives the motor 304, the transfer roller 305 is driven via a printer-driving-force transmission system and transfers the printing sheet 201, and the driving member 307 is driven for rotation together with the transfer roller 305. As the driving member 307 is driven for rotation, the print head 301 is driven in a direction perpendicular to the drawing (FIG. 3).

The image data are printed on the printing sheet 201 with the print head 301 ejecting ink onto the printing sheet 201 while moving over the printing sheet 201. The printed printing sheet 201 is transferred by the transfer roller 305 toward a side of the camera body 100 and is discharged automatically.

During printing, the print-monitor circuit 3 monitors the printing operations, in which the printing-sheet PI 300 disposed in the vicinity of the printing-sheet discharging slot 100b determines the transferred state of the printing sheet 201. The driven state of the print head 301 is determined by the print-head PI 302 detecting comb teeth of the comb-teeth gear 303 which is disposed such that it branches from the printer-driving-force transmission system. A problem in the print operations can be detected by determining signals outputted by the printing-sheet PI 300 and the print-head PI 302. Although according to the present embodiment, the comb-teeth gear 303 is disposed such that it branches from the printer-driving-force transmission system, the comb-teeth gear 303 may be integrated with the printer-driving-force transmission system.

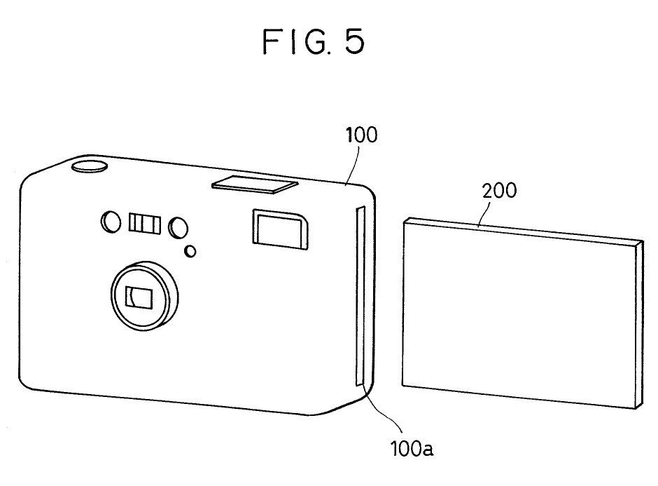

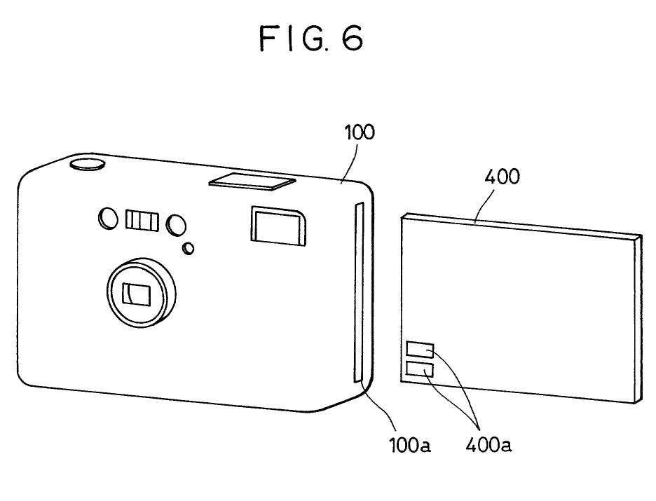

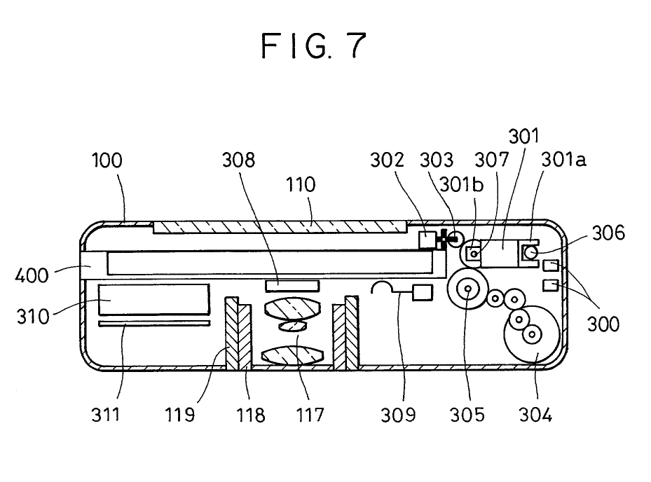

A case in which the function-extension unit substituting for the cartridge 200 is loaded to the camera body 100 is described below with reference to FIGS. 5 to 7. FIG. 5 is a perspective view of the camera body 100 of the printer-integrated camera shown in FIG. 1. The cartridge 200 is being removed from the camera body 100. FIG. 6 is a perspective view of the camera body 100 shown in FIG. 1 before a function-extension unit 400 is loaded. FIG. 7 is a sectional view of the camera body 100 of the printer-integrated camera shown in FIG. 1, in which the function5 extension unit 400 is loaded.

The camera body 100 is formed such that the function-extension unit 400 can be loaded instead of the cartridge 200. When the function-extension unit 200 is loaded instead of the cartridge 200, the cartridge 200 which is loaded must first be removed from the camera body 100 through the loading slot 100a.

Then, the function-extension unit 400 is inserted into the camera body 100 through the loading slot 100a. The function-extension unit 400 is, for example, a read-write memory card, a card-shaped battery pack, or a combination card including a memory and a battery combined with each other. The function-extension unit 400 has a substantially the same shape as that of the cartridge 200. However, the shape of the function-extension unit 400 is not necessarily the same as that of the cartridge 200, and the function-extension unit 400 may have any shape as long as it can be received in a space of the camera body 100 which is capable of receiving the cartridge 200. The function-extension unit 400 is provided with two conductive parts 400a which can be electrically connected to the tabs 309, respectively, when the function-extension unit 400 is received in the camera body 100. According to the present embodiment, the function-extension unit 400 is provided with the two conductive parts 400a because two tabs are provided at side of the camera body 100. However, the number of the conductive parts 400a is not limited to two, and it may vary according to the number of the tabs 309 provided at the side of the camera body 100.

When the function-extension unit 400 is loaded, the tabs 309 of the camera body 100 and the conductive parts 400a of the function-extension unit 400 are connected to each other. The communication-control circuit 7 of the camera body 100 can thereby communicate with the function-extension unit 400. The communication-control circuit 7 determines the category of the loaded function-extension unit 400, that is, whether the loaded function-extension unit 400 is a memory card, a battery pack, or a combination card, and control corresponding to the loaded function-extension unit 400 is performed.

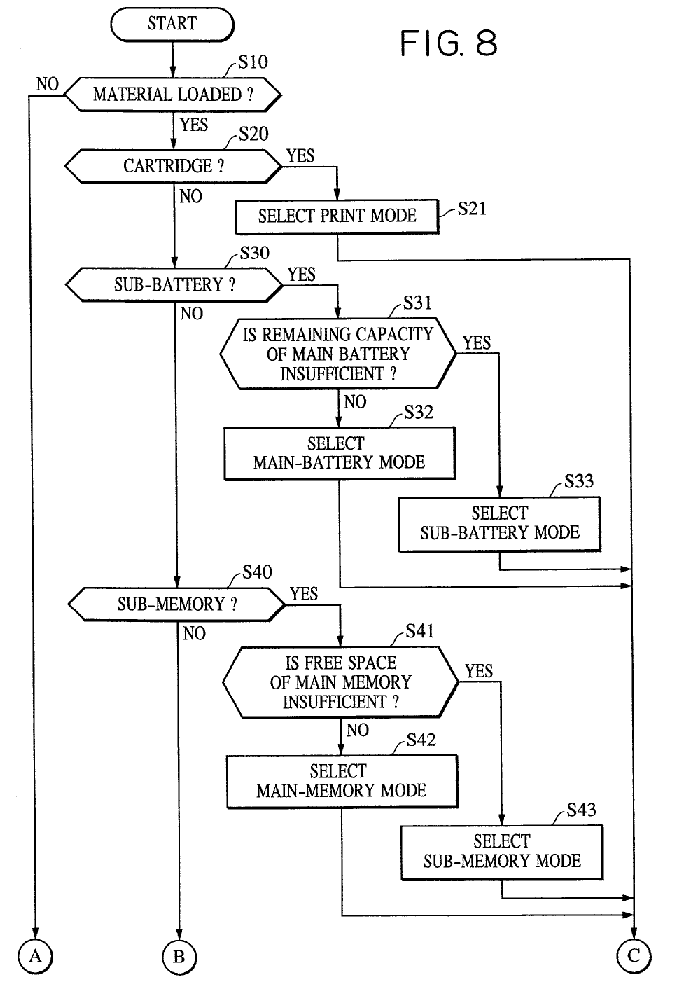

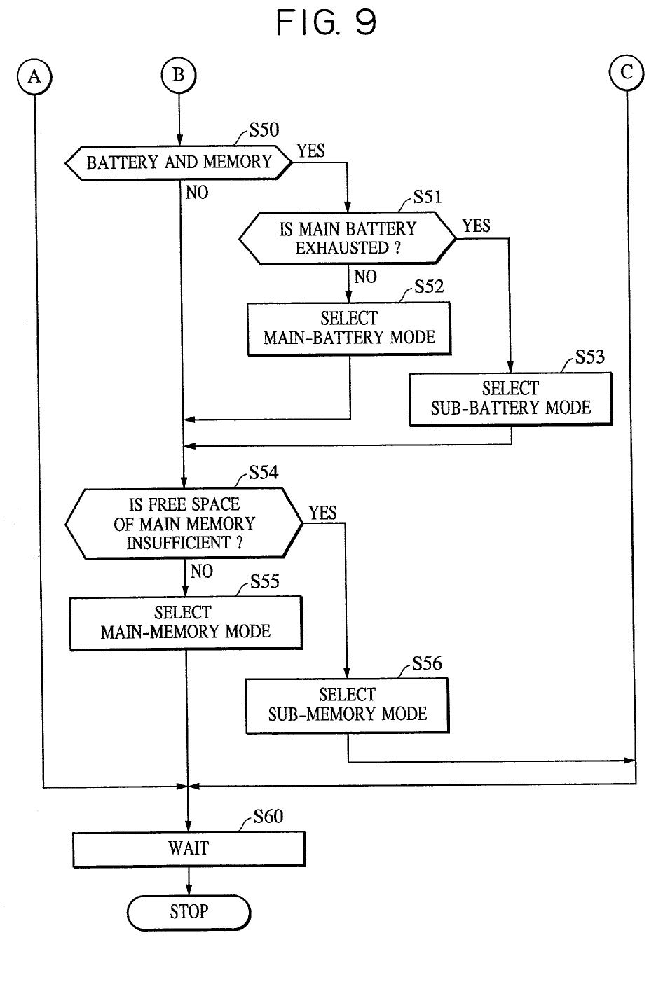

Mode-selection control performed when the cartridge 200 or the function-extension unit 400 is loaded to the printer-integrated camera is described below with reference to FIGS. 8 and 9. FIGS. 8 and 9 are flowcharts showing the steps of the mode-selection control when the cartridge 200 or the function-extension unit 400 is loaded to the printer-integrated camera shown in FIG. 1. The mode-selection control is performed by the camera-microcomputer 1.

In FIG. 8, it is determined according to an output from the loaded-material-detecting sensor whether or not a material (the cartridge 200 or the function-extension unit 400) is loaded (step S10). When it is determined that no material is loaded, the process proceeds to step S60 shown in FIG. 9 and moves into a waiting mode. When it is determined that a material is loaded, the process proceeds to step S20, and it is determined by the communication-control circuit 7 whether or not the loaded material is the cartridge 200. When it is determined that the loaded material is the cartridge 200, a print mode is selected in step S21, and the process proceeds to step S60 and moves into the waiting mode.

When it is determined in step S20 that the loaded material is not a cartridge, the process proceeds to step S30 and it is determined whether or not the loaded material is a battery pack. When it is determined that the loaded material is the battery pack, the process proceeds to step S31 and it is determined whether or not the remaining capacity of the main battery 310 is below a predetermined value. When the remaining capacity of the main battery 310 is not below the predetermined value, it is determined that the remaining capacity of the main battery 310 is sufficient, and the process proceeds to S32. In step S32, a main-battery mode in which the main battery 310 supplies electric power is selected and the process moves into the waiting mode in step S60. When the remaining capacity of the main-battery 310 is below the predetermined value, it is determined that the remaining capacity of the main battery 310 is insufficient, and the process proceeds to step S33. In step S33, a sub-battery mode in which the loaded battery pack supplies electric power is selected and the process moves into the waiting mode in step S60.

When it is determined in step S30 that the loaded material is not a battery pack, the process proceeds to step S40. In step S40, it is determined whether or not the loaded material is a memory card. When it is determined that the loaded material is a memory card, the process proceeds to step S41 and it is determined whether or not the free space of the main memory 311 is below a predetermined value. When the free space of the main memory 311 is not below the predetermined value, it is determined that the free space of the main memory 311 is sufficient and the process proceeds to step S42. In step S42, a main-memory mode in which image data are stored in the main memory 311 is selected, and the process proceeds to step S60 for waiting. When the free space of the main memory 311 is below the predetermined value, it is determined that the free space of the main memory 311 is insufficient and the process proceeds to step S43. In step S43, a sub-memory mode in which image data are stored in the memory card is selected, and the process proceeds to S60 for waiting.

When it is determined in step S40 that the loaded material is not a memory card, the process proceeds to step S50 shown in FIG. 9 and it is determined whether or not the loaded material is a combination card including a battery and a memory integrated with each other. When it is determined that the loaded material is the combination card, the process proceeds to step S51. In step S51, it is determined whether or not the remaining capacity of the main battery 310 is below a predetermined value. When the remaining capacity of the main battery 310 is not below the predetermined value, it is determined that the remaining capacity of the main battery 310 is sufficient, and the process proceeds to step S52. In step S52, the main-battery mode is selected and the process proceeds to step S54. When the remaining capacity of the main battery 310 is below the predetermined value, it is determined that the remaining capacity of the main battery 310 is insufficient, and the process proceeds to step S53. In step S53, the sub-battery mode in which the combination card supplies electric power is selected, and the process proceeds to step S54.

In step S54, it is determined whether or not the free space of the main memory 311 is below a predetermined value. When the free space of the main memory 311 is not below the predetermined value, it is determined that the free space of the main memory 311 is sufficient, and the process proceeds to step S55. In step S55, the main-memory mode is selected and the process proceeds to step S60 for waiting. When the free space of the main memory 311 is below the predetermined value, it is determined that the free space of the main memory 311 is insufficient, and the process proceeds to step S56. In step S56, the sub-memory mode in which image data are stored in the combination card is selected, and the process proceeds to step S60 for waiting.

A mode in which the battery pack, the memory card, or the combination card can be used is selected when either the battery pack, the memory card, or the combination card is loaded, instead of the cartridge 200, to the camera body 100. Therefore, the loaded battery pack, the memory card, or the combination card can be used when the remaining capacity of the main battery 310 or the free space of the main memory 311 is insufficient, whereby more functions of the printer-integrated camera can be added so that the printer-integrated camera becomes more useful.

Although according to the present embodiment, an ink-jet-type printer is used as a printing mechanism, the printing mechanism is not limited to such a printer. The present invention is applicable to other types of printing mechanism, such as a fusion-type thermal transfer printer and a sublimation-type thermal transfer printer.

An arrangement other than that which is described in the above embodiment is also applicable, in that the camera body 100 includes a storage medium which stores program codes of a software for realizing the functions described above and a CPU or MPU reads and performs the program codes stored in the storage medium.

In this case, the program codes read from the storage medium realize the functions according to the embodiment. Therefore, the storage medium storing the program codes is considered to be embraced in the scope of the present invention.

The storage medium for supplying the program codes includes, for example, a floppy disc, a hard disc, an optical disc, a magnetic optical disc, a CD-ROM, a CD-R, a magnetic tape, a nonvolatile memory card, and a ROM.

In the printer-integrated camera according to the present embodiment, a space for selectively receiving the printing medium and the function-extension unit is formed in the loading part, and the connection member for electrically connecting the printing apparatus to the function-extension unit received in the space is provided. Therefore, more function of the printing apparatus can be easily added by using the function-extension unit, thereby making the printing apparatus more useful.

When the function-extension unit includes a battery for supplying electric power to the printing apparatus via the connection member, the printing apparatus can be used for a longer time.

When the function-extension unit includes a data-storing medium which can write data and/or which can read data sent from the printing apparatus via the connection member, storage capacity for captured image data can be increased.

When the function-extension unit includes the battery for supplying electric power to the printing apparatus via the connection member and the data-storing medium which can write data and/or which can read data sent from the printing apparatus via the connection member, the battery and the data-storing medium assembled with each other as a unit, the printing apparatus can be used for a longer time and the storage capacity thereof for storing captured image data can be increased.

The printing apparatus according to the present invention is provided with a determination device which determines the category of the function-extension unit when the function-extension unit is received in the space formed in the loading part. The printing apparatus is also provided with a mode selector which selects a function mode in accordance with the determined category of the function-extension unit. Therefore, more function of the printing apparatus can be easily added by using the function-extension unit, and the printing apparatus becomes more useful.

When the function-extension unit received in the space is a battery, the printing apparatus can be used for a longer time by selecting a mode in which the function-extension unit supplies electric power.

When the function-extension unit received in the space is a data-storing medium, storage capacity for captured image data can be increased by selecting a mode in which data can be read from and written to the function-extension unit.

When the function-extension unit received in the space includes a battery and a data-storing medium assembled with each other as a unit, the printing apparatus can be used for a longer time and storage capacity for captured image data can be increased by selecting a mode in which the function-extension unit supplies electric power and a mode in which data can be read from and written to the function-extension unit.

The functions to be added by the function-extension unit, according to the present invention, are not limited to those which are described above. The function-extension unit may be, for example, a radio terminal unit.

Although according to the above embodiment, the printer is integrated with a camera, the printer may be independent from the camera, according to the present invention.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded with the broadest interpretation so as to encompass all such modifications and equivalent structures and functions.

What is claimed is:

1. A printing apparatus comprising:
a loading part that receives a printing medium loaded thereto, said loading part being capable of receiving a function-extension unit when the printing medium is unloaded; and
a connection member that forms an electrical connection to the function-extension unit loaded to said loading part.

2. A printing apparatus according to claim 1, wherein said printing apparatus is integrated with an imaging device and prints an image which has been captured by the imaging device.

3. A printing apparatus according to claim 1, wherein the function-extension unit comprises a battery.

4. A printing apparatus according to claim 1, wherein the function-extension unit comprises a memory.

5. A printing apparatus according to claim 1, further comprising:
a determination device that determines, via said connection member, the function-extension unit loaded to said loading part.

6. A printing apparatus according to claim 5, wherein said determination device sets a mode in accordance with a result of the determination.

7. A printing apparatus according to claim 1, wherein the loading part is provided with a space for selectively receiving the printing medium and the function-extension unit.

8. A printing apparatus comprising:
a loading part that receives a printing medium loaded thereto, said loading part being capable of receiving a function-extension unit when the printing medium is unloaded; and
a determination device that determines the function-extension unit loaded to said loading part.

9. A printing apparatus according to claim 8, wherein said determination device determines a category of the function-extension unit.

10. A printing apparatus according to claim 8, wherein said determination device sets a mode in accordance with a result of the determination.

11. A printer apparatus according to claim 8, wherein the printing apparatus is integrated with an imaging device and prints an image which has been captured by the imaging device.

12. A printing apparatus according to claim 8, wherein the function-extension unit comprises a battery.

13. A printing apparatus according to claim 8, wherein the function-extension unit comprises a memory.

14. A printing apparatus according to claim 8, wherein the loading part is provided with a space for selectively receiving the printing medium and the function-extension unit.
